(19) United States
(12) Patent Application Publication
(10) Pub. No.: US 2016/0116652 A1
(43) Pub. Date: Apr. 28, 2016

(54) METHOD FOR CONTROLLING THE OPTICAL PROPERTIES OF UV FILTER LAYERS

(71) Applicant: Merck Patent GmbH, Darmstadt (DE)

(72) Inventors: Marc Haeming, Neudenau (DE); Philipp Pacak, Darmstadt (DE); Klaus Bonrad, Alsbach-Haehnlein (DE)

(73) Assignee: Merck Patent GmbH, Darmstadt (DE)

(21) Appl. No.: 14/898,507

(22) PCT Filed: May 28, 2014
(86) PCT No.: PCT/EP2014/001434

§ 371 Date: Dec. 15, 2015

(30) Foreign Application Priority Data
Jun. 20, 2013 (EP) 13003151.1

(51) Int. Cl. G02B 5/20; G02B 5/22

(52) U.S. Cl. CPC G02B 5/208; G02B 5/223

(57) ABSTRACT

The invention relates to a method for controlling the optical properties of UV filter layers, in particular for controlling the UV absorption properties of metal oxide-containing UV filter layers, to UV filter layers produced thereby, and to the use thereof, in particular for the production of electronic components.

The invention relates to a method for controlling the optical properties of UV filter layers, in particular for controlling the UV absorption properties of metal oxide-containing UV filter layers, to UV filter layers produced thereby, and to the use thereof, in particular for the production of electronic components.

Metal-oxide layers which are transparent in the visible wavelength region are employed in a variety of forms as optical layers, for example in classical optical applications, such as spectacles or other optical glasses. However, they are also used in electronic components, such as various diodes (LEDs, OLEDs), transistors, solar cells and the like. In the latter, protection against the influence of ultraviolet radiation is frequently necessary, since they also contain, inter alia, organic materials, which age rapidly under the influence of ultraviolet radiation. Metal oxides which are transparent in the visible wavelength region and which have a certain UV absorption are therefore also employed as UV-absorbent materials for electronic components. In addition, some of these metal oxides also have electrically conducting or semiconducting properties, meaning that they can at the same time be used as conductors or semiconductors in electronic components.

In order to be able to combine the positive UV-screening properties of certain metal oxides or metal mixed oxides with good electrically conducting or semiconducting properties, complex production methods for optical layers comprising metal oxides or metal mixed oxides, such as, for example, ITO, ZnO, IZO or IGZO, are currently employed.

These are, in particular, methods such as sputtering or chemical or physical vapour deposition methods (CVD—chemical vapour deposition, PVD—physical vapour deposition). These methods can be controlled relatively well, meaning that the desired characteristics both in relation to the optical properties and also to the electrically conducting properties can be achieved. However, CVD and PVD methods are complex in equipment terms and cannot be operated under atmospheric pressure. In the sputtering method, the composition of the layer to be generated is determined by the prespecified sputter target and cannot be controlled in a variable manner.

Furthermore, metal-oxide layers are usually also obtained by acid- or base-catalysed sol-gel methods. However, this method has the disadvantage that the sols used generally have only an extremely short lifetime at a constant quality and constantly change gradually during storage, meaning that industrial large-scale production is difficult to control.

All the methods described have in common the disadvantage that the methods do not permit relatively large variations in the composition of the layers obtained. However, the material composition of the respective layer also determines its optical behaviour, meaning that there are also no possible variations in this area, in particular with respect to the degree of UV absorption. In addition, it would be advantageous to have available a simple, readily controllable application method which is suitable for mass production, works at atmospheric pressure and under a standard atmosphere and only requires low equipment complexity.

There is therefore a need for a simple method for the application of metal-oxide layers to substrates in which the optical properties, in particular the UV absorption properties, of the layers can be matched individually to the respective application requirements, the material composition of the layers can be varied as necessary and in which the electrically conducting or semiconducting properties which are simultaneously present in the metal-oxide layers suffer no qualitative adverse effects.

The object of the invention is therefore to provide a method for controlling the UV absorption properties of metal oxide-containing layers which is suitable for mass production and with the aid of which the above-mentioned requirements of UV filter layers are satisfied.

A further object of the present invention consists in providing metal-oxide layers which can be produced by the said method and whose optical properties can be adjusted in a variable manner.

In addition, an object of the invention consists in indicating the use of the metal-oxide layers generated in this way.

Surprisingly, it has now been found that the above-mentioned objects of the invention are achieved by a simple wet-chemical method in which an organometallic compound is applied to a substrate and converted into a metal oxide or metal mixed oxide, where the application conditions are varied and different UV absorption properties of the resultant layers are obtained depending on the respective variation.

The object of the invention is therefore achieved by a method for controlling the UV absorption properties of metal oxide-containing UV filter layers, where
A) a layer comprising an organometallic compound is applied to a substrate and converted into a layer of a metal oxide or a metal mixed oxide at a temperature in the range from >230° C. to 500° C., and/or
B) an organometallic compound is applied to a substrate and converted into a metal oxide or metal mixed oxide and where the application and conversion takes place a number of times successively with formation of multilayered systems comprising metal oxides and/or metal mixed oxides and the organometallic compound for an individual layer is applied in a solution or dispersion comprising same in a concentration which reduces with increasing total number of layers in the multilayered systems, where the concentration in each of the individual layers is the same within a single multilayered system.

The object of the invention is furthermore also achieved by metal oxide-containing filter layers which have been produced by the said method.

In addition, the object of the invention is also achieved by the use of the metal oxide-containing UV filter layers produced in accordance with the invention as UV filter layers and electrically semiconducting layers in electronic components.

In accordance with the invention, the UV-absorbent region is regarded as being the wavelength range of incident optical radiation between 200 and 400 nm. By definition, the wavelength range between 100 and 200 nm (100-280 nm, UV-C radiation) likewise belongs to UV radiation. However, natural radiation in the wavelength range from 100 to 280 nm is already absorbed virtually completely in the atmosphere, meaning that investigations into the absorption of optical radiation in the wavelength range from 100 to 200 nm are irrelevant in relation to the present invention.

In accordance with the invention, the production of UV-absorbent and at the same time electrically semiconducting or conducting metal-oxide layers is carried out from organometallic precursor compounds thereof dissolved in solvents or dispersed in liquid dispersion media, i.e. from metal-oxide precursor solutions or metal-oxide precursor dispersions, which can be converted comparatively simply into coating compositions or printing inks which can be employed in standard coating and printing methods for mass production.

Although many of the known organometallic precursor compounds of UV-absorbent, semiconducting or conducting metal oxides (i.e. organometallic compounds which decompose into volatile constituents, such as carbon dioxide, acetone, etc., and into the desired metal oxides on subsequent treatment, which takes place thermally and/or by means of actinic radiation (UV and/or IR)) are suitable for the method according to the invention, preference is given for the purposes of the present invention to the use of organometallic compounds which are metal carboxylate complexes of the metals zinc or tin, optionally mixed with metal carboxylate complexes of the metals indium and/or gallium, having the coordination numbers 3 to 6, each of which contains at least one ligand from the group of the alkoxyiminocarboxylic acids (oximates), or also metal complexes of the said metals with enolate ligands, where the term “metals” is in accordance with the invention taken to mean the above-mentioned elements, which can have either metal or semimetal or also transition-metal properties. However, it is also possible to use the acetates of the said metals, which can likewise easily be converted into the metal oxides.

Mixtures of metal carboxylate complexes or metal enolates of at least two different metals of those mentioned are particularly preferably employed.

In particular, the at least one ligand is a 2-(methoxyimino)alkanoate, a 2-(ethoxyimino)alkanoate or a 2-(hydroxyimino)alkanoate, which are likewise called oximates below. These ligands are synthesised by condensation of alpha-keto acids or oxocarboxylic acids with hydroxylamines or alkylhydroxylamines in the presence of bases in aqueous or methanolic solution.

The ligand employed is likewise preferably an enolate, in particular acetylacetonate, which is also common in the form of acetylacetonate complexes of various metals for other industrial purposes and is therefore commercially available.

All ligands of the metal carboxylate complexes employed in accordance with the invention are preferably alkoxyiminocarboxylic acid ligands, in particular those mentioned above, or complexes in which the alkoxyiminocarboxylic acid ligands are additionally complexed only with H₂O, but no further ligands are otherwise present in the metal carboxylate complex.

The metal acetylacetonates described above are also preferably complexes which likewise contain no further ligands apart from acetylacetonate.

If organometallic oximate precursor compounds of various metals are employed as starting materials, it is advantageous for all starting materials to belong to the same substance group, i.e. in each case oximates are mixed with oximates.

The preparation of the metal carboxylate complexes containing alkoxyiminocarboxylic acid ligands which are preferably employed in accordance with the invention has already been described in greater detail in the documents WO 2009/010142 A2 and WO 2010/078907 A1. To this extent, reference is made to the said documents in their full scope.

In general, the metal-oxide precursors, i.e. the organic gallium, indium, zinc, or tin complexes, form at room temperature by reaction of an oxocarboxylic acid with at least one hydroxylamine or alkylhydroxylamine in the presence of a base, such as, for example, tetraethylammonium hydrogencarbonate or sodium hydrogencarbonate, and subsequent addition of an inorganic gallium, indium, zinc or tin salt, such as, for example, gallium nitrate hexahydrate, anhydrous indium chloride or tin chloride pentahydrate. The oxocarboxylic acid employed can be all representatives of this class of compound. Preferably, however, oxoacetic acid, oxopropionic acid or oxobutyric acid are employed.

The said organometallic metal-oxide precursor compounds (precursors) are preferably employed in accordance with the invention in dissolved or dispersed form. For this purpose, they are dissolved in suitable solvents or dispersed in suitable dispersion media in suitable concentrations, which in each case have to be adjusted to the coating method to be employed and to the number and composition of the metal-oxide precursor layers to be applied.

Suitable solvents or dispersion media here are water and/or organic solvents, for example alcohols, carboxylic acids, esters, ethers, aldehydes, ketones, amines, amides or also aromatic compounds. It is also possible to employ mixtures of a plurality of organic solvents or dispersion media or mixtures of water with organic solvents or dispersion media.

The metal carboxylate complexes with alkoxyiminocarboxylic acid ligands (oximates) already described above are preferably dissolved in 2-methoxyethanol or tetrahydrofuran.

In a first embodiment of the present invention, firstly an organometallic compound or a mixture of organometallic compounds, in dissolved or dispersed form, i.e. the metal-oxide precursor solution or dispersion, is applied as a single layer to the respective substrate, giving a metal-oxide precursor layer, which is subsequently optionally dried and then converted thermally into a metal-oxide layer or, depending on the composition of the starting materials, metal mixed-oxide layer.

The thermal treatment is carried out at temperatures in the range from >230° C. to 500° C. The temperature treatment here is carried out in air or under protective gas.

It has surprisingly been found that variation of the temperature treatment within the range from >230° C. to 500° C. with constant material composition (see description above) leads to different UV absorption properties of the resultant layer.

The UV absorption here in the UV-A region (315-400 nm) and in the UV-B region (280-315 nm) as well as the absorption of UV-C radiation in the range from 200-280 nm is greater the higher the temperature treatment is carried out within the limits of the above-mentioned temperature range.

The UV absorption properties of the metal oxide-containing layers to be generated are therefore advantageously controlled via stepwise adaptation of the conversion temperature (depending on the desired UV absorption properties at 250, 300, 350, 400, 450 or 500° C.) of the metal-oxide precursor or precursor mixture into the metal oxide or metal mixed oxide.

Whereas the metal-oxide layer or metal mixed-oxide layer still transmits at least 90% of UV-A radiation and at least 75% of UV-B radiation at a conversion temperature in the range from >230° C. to 350° C., already significant absorption in the UV-A and in the UV-B region, which is up to 25% of UV-A radiation and up to 40% of UV-B radiation, takes place at a conversion temperature in the range from >350° C. to 500° C., in particular from 450° C. on.

Incident light in the visible wavelength region (400 to 780 nm) is, by contrast, transmitted virtually completely, but at least to the extent of 95%, in the case of layers which are converted into metal oxide-containing layers throughout the range from >230° C. to 500° C. This means that the metal oxide-containing layers generated from the above-mentioned materials are optically transparent in the visible region.

A graphic representation of the influence of the temperature treatment on the UV absorption of a 3-layer system comprising IZO (3×100 mg/g) indium zinc oxide) is shown in FIG. 1. Similar investigations on a single-layer system comprising 1×100 mg/g of IZO in each case exhibit approximately the same curve shape.

The UV absorption in the range from 200 nm to 400 nm of a metal-oxide layer or metal mixed-oxide layer generated in accordance with the invention can therefore be controlled, depending on the area of application of the corresponding layers, by simple temperature management. At the same time, the metal-oxide layer can be applied to a corresponding substrate by a simple, wet-chemical method and converted into a metal-oxide layer in a simple manner.

If the semiconducting properties of the metal-oxide or metal mixed-oxide layers generated are of particular importance in the intended application, the electrical conductivity of the metal oxide-containing layer generated can be increased further if the temperature treatment is not carried out in air, but instead under protective gas, preferably under argon.

In a second embodiment of the present invention, the application of an organometallic compound and conversion thereof into a metal oxide or into a metal mixed oxide takes place a number of times successively, so that in each case a multilayered system comprising metal oxides, metal mixed oxides or comprising a combination of the two is obtained. The organometallic compound has a concentration in a solution or dispersion comprising same which in each case reduces with increasing total number of layers, i.e. is high in the case of a small number of layers and is low in the case of a large number of layers.

At least 2 and up to 25 layers, preferably 2 to 15 layers, are applied successively and one on top of the other to the substrate, so that a multilayered system comprising 2 to 25 individual layers forms.

It is important in accordance with the invention that the organometallic compounds from each of the individual layers are converted separately into metal oxides or metal mixed oxides before the next layer comprising organometallic compounds is applied. In this way of carrying out the method, smooth interfaces form between the individual layers, where the inner regions of the individual layer in each case still have a certain porosity. FIG. 3 shows the diagrammatic representation of the material density of a single-layered IZO layer (comprising oximate precursors).

FIG. 4 shows the diagrammatic representation of the material density of a double-layered IZO layer (comprising oximate precursors). The material application of IZO per unit area is in each case identical in FIG. 3 and FIG. 4.

Although the mechanism of action of these multilayered layers with respect to UV absorption has not been fully clarified, it is thought that the porosity in the interior of the individual layers and the increasing number of layers results in the differences in UV absorption behaviour of the multilayered layer obtained in accordance with the invention.

The conversion of the organometallic compounds into metal oxides or metal mixed oxides need not necessarily take place thermally in this second embodiment of the invention, but may also take place by irradiation with actinic radiation, i.e. with UV and/or IR radiation, in addition or as an alternative to the thermal treatment. In the case of UV irradiation, wavelengths<400 nm, preferably in the range from 150 to 380 nm, are employed. IR radiation can be employed with wavelengths of >800 nm, preferably from >800 to 3000 nm. This treatment also causes decomposition of the organometallic precursors and the release of volatile organic constituents and optionally water, so that a metal-oxide layer or metal mixed-oxide layer remains on the substrate.

The concentration of the organometallic compounds (metal-oxide precursor compounds) in the solution or dispersion to be applied is in accordance with the invention in the range from 1 to 10% by weight, based on the weight of the solution or dispersion. At least 2 and up to 25 layers are applied to the substrate, so that a multilayered system forms. A low concentration of, for example, 1.5% by weight is applied at least 10 times here, preferably 12 to 20 times, successively to the substrate and converted into the corresponding metal oxide or metal mixed oxide, whereas a precursor solution which comprises 10% by weight of an organic metal-oxide precursor is only applied twice to the substrate.

In this way, multilayered systems which do not exceed a total (dry) thickness of 200 nm form. The use of such multilayered systems both as UV filter layers and also, if necessary, as semiconducting layers having variable UV absorption properties is thus possible.

Surprisingly, it has been found that a significant increase in the UV absorption throughout the range from 200 to 400 nm investigated occurs with increasing number of layers at the same time as a reduction in the concentration of the organometallic compound (metal-oxide precursor) in the solution or dispersion for the respective individual layer. Whereas, for example, double application of a 10% by weight metal-oxide precursor solution results in UV absorption in the UV-A region of up to 25% and absorption in the UV-B region of up to 40% of the incident light, UV absorption of up to 50% in the UV-A region and up to 80% of the incident light in the UV-B region can be achieved in the case of 13-fold application of a metal-oxide precursor solution comprising the same materials, but in a respective concentration of 1.5% by weight, based on the weight of the solution.

FIG. 2 shows a representation of the influence of concentration and number of layers for a multilayered system comprising IZO.

Simple variation of the concentration of the organometallic precursor compound in the respective application medium and the number of layers applied one on top of the other therefore enables the UV absorption throughout the UV range from 200 to 400 nm investigated to be adjusted intentionally in a simple manner matched to the respective requirements.

In addition, multilayered systems comprising the above-mentioned metal oxides or metal mixed oxides also have very good electrically semiconducting properties. These can also be improved further in the multilayered systems according to the invention by additional heating in a protective-gas atmosphere, in particular in argon at a temperature in the range from 200-300° C.

With respect to the materials employed and the method according to the invention, the second embodiment of the present invention also gives metal oxide-containing layers which are virtually completely transparent, but at least to the extent of 95%, in the wavelength range from 400 to 780 nm, i.e. transmit incident light of the said wavelengths.

The influence of the multilayered system having varying composition in concentration and optionally material described in the second embodiment of the present invention and the associated possible variations on the controllability of the UV absorption properties of UV absorption layers is greater than the influence of the temperature management alone described in the first embodiment. The second embodiment of the present invention is therefore preferred.

However, especial preference is given to the embodiment of the present invention in which the first and second embodiments are combined with one another, i.e. the method for controlling the UV absorption properties of UV-absorbent metal-oxide layers in which the conversion of the organometallic metal-oxide precursor compounds into a metal oxide or metal mixed oxide takes place thermally and in addition a multilayered system comprising at least two metal oxide-containing layers is generated.

The application of the individual metal-oxide precursor layers for an individual metal-oxide layer or metal mixed-oxide layer and likewise for the multilayered system in accordance with the second embodiment of the present invention to a substrate can be carried out by means of various known coating and printing methods. In particular, a spin-coating method, a blade-coating method, a wire-coating method or a spray-coating method, or also conventional printing processes, such as ink-jet printing, flexographic printing, offset printing, slot die printing and screen printing, are suitable for this purpose. The spin-coating method and the ink-jet method are particularly preferred here.

Suitable substrates are solid substrates, such as glass, ceramic, metal or plastic, but also, in particular, flexible substrates, such as plastic films or metal foils. These substrates may also already have been pre-coated with a wide variety of materials, depending on the application.

The present invention also relates to a UV-absorbent coating comprising metal oxides and/or metal mixed oxides which, besides UV-absorbent properties which can be adjusted in a variable manner, has optical transparency in the visible wavelength region (VIS) and likewise electrically semiconducting properties and has been produced by the method according to the invention.

The layer structure, the material composition and the layer-thickness ratios of UV absorption layers produced in this way have already been described in detail above. According to the above description, it is additionally self-evident that the term “metal oxide” for the metal-oxide multilayered layer according to the invention includes pure metal oxides and metal mixed oxides as well as doped forms thereof.

The present invention also relates to the use of the UV-absorbent metal oxide-containing layers described above for the production of electronic components, in particular for the production of semiconducting functional layers for these components.

Electronic components which come into consideration here are, in particular, various diodes, such as LEDs and OLEDs, but also transistors and solar cells.

The method according to the invention for controlling the UV absorption properties of metal oxide-containing UV absorption layers leads to metal oxide-containing UV absorption layers which can be applied to conventional substrates in simple, wet-chemical methods under normal pressure conditions and are therefore suitable for the mass production of such UV absorption layers. At the same time, the degree of UV absorption can be adjusted in a variable manner in accordance with the respective application requirements by simple variations in temperature management and/or layer structure. In addition, the metal-oxide layers and/or metal mixed-oxide layers generated in this way also have semiconducting properties, which can likewise be adjusted, if necessary, through the material composition and also through the possible layer-thickness variations. The method according to the invention thus enables, in a simple and inexpensive manner, the mass production of metal oxide-containing UV filter layers which can advantageously be varied in composition and UV filter properties, depending on the application, and thus lead in a very inexpensive manner to coatings having versatile possible uses which combine both UV filter properties and also electrically semiconducting properties.

The following examples are intended to illustrate the present invention. However, they should in no way be regarded as limiting. All compounds or components which can be used in the preparations are either known and commercially available or can be synthesised by known methods.

### LIST OF THE FIGURES

FIG. 1: shows the dependence of the UV absorption of a 3-layered IZO layer on the heating temperature (conversion temperature into the metal mixed oxide) of the precursor according to Example 1

FIG. 2: shows the dependence of the UV absorption on the number of layers in a multilayered system comprising IZO and on the corresponding precursor concentration in accordance with Example 2

FIG. 3: shows the diagrammatic representation of the material density of an individual IZO layer over the cross section of the layer

FIG. 4: shows the diagrammatic representation of the material density of a double-layered IZO layer over the cross section of the double-layer system

### EXAMPLES

### Example 1

### Production of a Metal-Oxide Layer System (IZO) from a 10% by Weight IZO (Indium Zinc Oxide) Precursor Solution on the Basis of Oximate Precursors

A 10% by weight solution of 0.10 g of zinc oximate in 0.90 g of 2-methoxyethanol is mixed with a 10% by weight solution of 0.10 g of indium oximate in 0.90 g of 2-methoxyethanol in such a way that the molar ratio in the mixture In:Zn=1.5:1. This mixture is mixed homogeneously for about 5 minutes in an ultrasound bath. If necessary, filtration (20 μm pore size) can subsequently be carried out. A purified quartz substrate is coated with the precursor solution, where the process consisting of the following 4 process steps is carried out three times successively:
application of the precursor solution by spin coating (30 s, 2500 rpm),
drying at room temperature (10 s),
thermal treatment (4 min),
cooling to room temperature.

In each case 3 quartz substrates are coated, which are each thermally treated at various temperatures. The temperature is 250° C., 350° C. or 450° C.

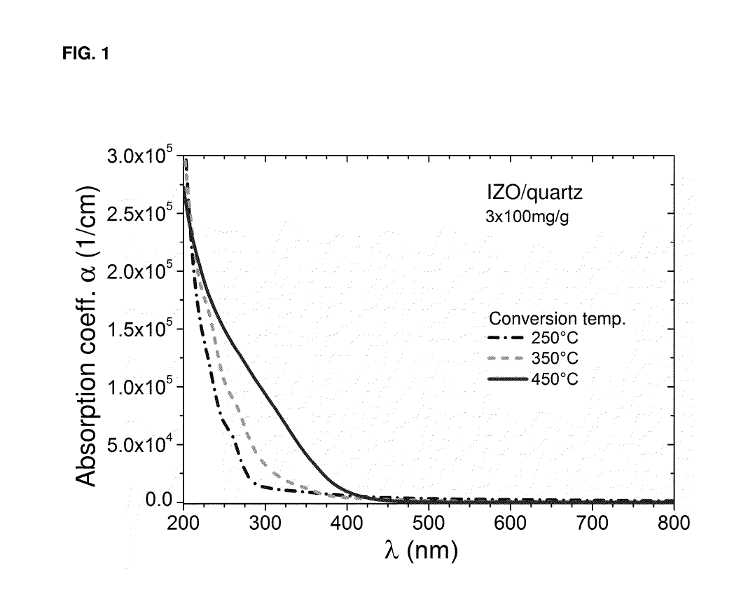

FIG. 1 shows the dependence of the absorption coefficient α on the heating temperature of the individual samples. The spectral width of the transmitted light increases with reduced heating temperature, while the absorption, in particular in the UV-A and UV-B region, increases significantly with increasing heating temperature.

### Example 2

### Production of Multilayered Semiconductor Layer Systems from IZO Precursor Solutions on the Basis of Oximate Precursors

x % by weight IZO precursor solutions are prepared analogously to Example 1, where x has the values 1.5; 3.0; 5.0 and 10. The substrates prepared as in Example 1 are coated with IZO precursor solutions by repeated performance of the process steps described in Example 1 and converted successively into an IZO multilayered system. A different number of layers, each having a different concentration of the precursor solution, are applied to each of several quartz substrates. The following layers are applied:

2-layer system comprising in each case 10% by weight solution
4-layer system comprising in each case 5% by weight solution
7-layer system comprising in each case 3% by weight solution
13-layer system comprising in each case 1.5% by weight solution

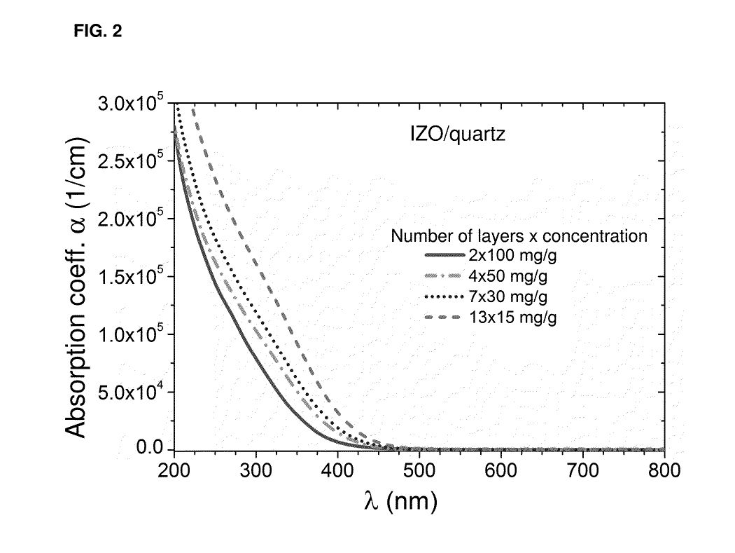

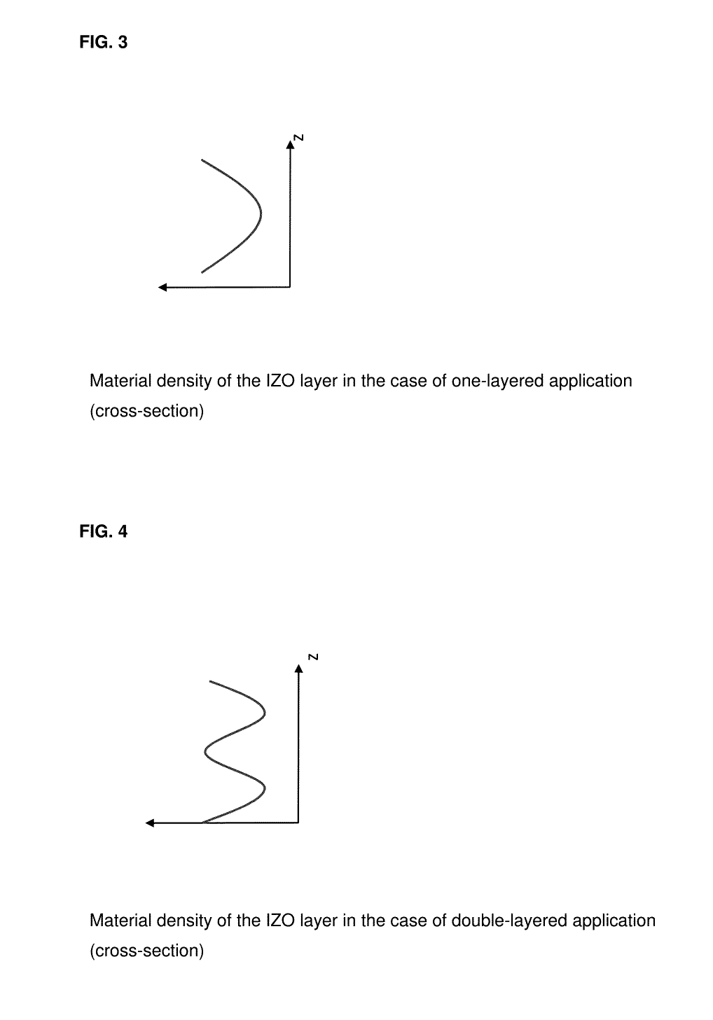

FIG. 2 shows the dependence of the absorption coefficient α on the number of layers and the concentration of the precursor solution. The absorption in the UV-A and in the UV-B region is then the greatest with increasing number of layers at the same time as a low concentration of the precursor solution, whereas the spectral width of the transmitted light increases with falling number of layers at the same time as a high concentration of the precursor solution.

1. Method for controlling the UV absorption properties of metal oxide-containing UV filter layers, where
A) a layer comprising an organometallic compound is applied to a substrate and converted into a layer comprising a metal oxide or a metal mixed oxide at a temperature in the range from >230° C. to 500° C., and/or
B) an organometallic compound is applied to a substrate and converted into a metal oxide or metal mixed oxide and where the application and conversion takes place a number of times successively with formation of multilayered systems comprising metal oxides and/or metal mixed oxides and the organometallic compound for an individual layer is applied in a solution or dispersion comprising same in a concentration which reduces with increasing total number of layers in the multilayered systems, where the concentration in each of the individual layers is the same within a single multilayered system.

2. Method according to claim 1, characterised in that the organometallic compound is a metal oximate, a metal acetylacetonate and/or a metal acetate.

3. Method according to claim 1, characterised in that the metal oxide and/or metal mixed oxide contains at least tin or zinc.

4. Method according to claim 1, characterised in that the metal oxide and/or metal mixed oxide is ITO, ZnO, IZO or IGZO.

5. Method according to claim 1, characterised in that the layer or multilayered system comprising metal oxides and/or metal mixed oxides have a total layer thickness of at most 200 nm.

6. Method according to claim 1, characterised in that a multilayered system is produced from 2 to 25 individual layers comprising metal oxides and/or metal mixed oxides.

7. Method according to claim 1, characterised in that a layer or multilayered system comprising metal oxides and/or metal mixed oxides is obtained which transmits incident light in the wavelength range from 400 nm to 780 nm to the extent of at least 95%.

8. Method according to claim 1, characterised in that a layer or multilayered system comprising metal oxides and/or metal mixed oxides is obtained which absorbs incident light in the wavelength range from 315 nm to 400 nm to the extent of up to 25%.

9. Method according to claim 1, characterised in that a layer or multilayered system comprising metal oxides and/or metal mixed oxides is obtained which absorbs incident light in the wavelength range from 315 nm to 400 nm to the extent of up to 50%.

10. Metal oxide-containing UV filter layers produced by a method according to claim 1.

11. Metal oxide-containing UV filter layers according to claim 10, characterised in that they comprise metal oxides and/or metal mixed oxides of the elements tin or zinc.

12. An electronic component comprising a UV filter layer, wherein said UV filter layer is a metal oxide-containing UV filter layer according to claim 10.

13. The electronic component according to claim 12, wherein said electronic component is selected from are LEDs, OLEDs, transistors, and solar cells.
